(19) United States
(12) Patent Application Publication
(10) Pub. No.: US 2012/0037042 A1
(43) Pub. Date: Feb. 16, 2012

(54) Sealing Paste

(75) Inventors: Peter Ellenberger, Feldmeilen (CH); Herbert Egli, Kunten (CH); Giuseppe Viscomi, Kloten (CH)

(73) Assignee: Constuction Research & Technology GMBH, Trostberg (DE)

(21) Appl. No.: 13/139,795

(22) PCT Filed: Nov. 25, 2009
(86) PCT No.: PCT/EP09/65792

§ 371 Date: Nov. 1, 2011

(30) Foreign Application Priority Data
Dec. 17, 2008 (EP) 08171950.2

(51) Int. Cl. C09D 1/00

(52) U.S. Cl. 106/287.26

(57) ABSTRACT

The present invention relates to mixtures, preferably sealing pastes, particularly preferably shield tail sealing pastes, and the use of the mixtures according to the invention for sealing construction elements and/or construction machines, in particular for preferably temporary sealing of the transition between shield tail of a tunnel boring machine and the pipe lining or tubbing lining of the tunnel securing means.

The present invention relates to mixtures, preferably sealing pastes, particularly preferably shield tail sealing pastes, and the use of the mixtures according to the invention for sealing construction elements and/or construction machines, in particular for preferably temporary sealing of the transition between shield tail of a tunnel boring machine and the pipe lining or tubbing lining of the tunnel securing means.

Sealing pastes based on swellable clay, in particular bentonite, are known in the prior art. EP-A-1391566 describes a method for producing a sealing layer, in which swellable bentonite is arranged under pressure before that part of a structure which is to be sealed.

The present invention is particularly important in the area of tunnel construction technology, in particular in tunnel boring by means of a shielded tunnel boring machine (TBM). In this technology, the gap between the shield of the TBM and the pipe lining or tubbing lining of the tunnel securing means must be sealed with a sealing paste during the advance and installation of the tunnel securing means. In general, the sealing paste is injected, for example by means of a pump, into generally two annular cavities which are fixed by generally three annular steel brushes at the end of the shield tail of the TBM. Further details of the use of shield tail sealing pastes in tunnel construction in association with tunnel boring machines is also to be found in DE-A-102006056263.

“Bernhard Maidl, Martin Herrenknecht, Lothar Anheuser, Berlin: Ernst, Verlag für Architektur and techn. Wiss., 1995, pages 116-119” gives an overview of a particularly important partial aspect of tunnel boring machine technology, namely the tunnel securing means. In particular, the use of shield tail sealing pastes for sealing the gap between a tunnel securing means and the surroundings is discussed.

Shield tail seal greases which are based on synthetically produced fats and oils based on the raw material mineral oil are likewise known. Owing to their poor environmental compatibility, they are less advantageous to use in applications in which the probability of contact with groundwater is high.

Specific applications of more environmentally friendly sealing compounds (particularly comprising bentonite) in the area of tunnel boring machine technology (TBM technology) are in particular for sealing the shield tail of a TBM, disclosed in the documents DE-A-102006056263, WO01/73265 and EP-A-0607053.

DE-A-102006056263 describes in this context mixtures of phyllosilicates, in particular bentonite, stabilizers, water, fibres, fillers and a vegetable oil. Alcohol is likewise mentioned, but which alcohols are suitable for this purpose or which object and which effects could be ascribed to the alcohols is not mentioned anywhere.

WO01/73265 describes a sealing composition which can be used in particular in emergencies for preventing the penetration of water into the shield tail. The composition of the sealing pastes is similar to those of DE-A-102006056263. With the exception of polyvinyl alcohol, alcohols are not mentioned.

EP-A-0607053 describes sealing pastes which contain mica, water, fibres and hydrogenated vegetable oil.

The sealing pastes of the three abovementioned documents in the area of TBM technology are in further need of improvement with regard to the sealing performance of the materials which is described there. In particular, the sealing materials should be more resistant to the penetration of water, in particular of water under pressure, from the environment of the tunnel boring machine (groundwater, etc.). However, the processability in the preparation of the materials (kneadability) and in particular the pumpability required for use at the building site should not deteriorate but as far as possible further improve.

It is also desired to obtain more productive materials for effective sealing, where the use of less material is necessary.

It is therefore an object to eliminate or to reduce the above-described disadvantages of the prior art. In particular, the aim is to achieve an improvement in the sealing properties in combination with good processability, good cost-efficiency, environmental compatibility and good productivity of the products.

The above object was achieved by the use of a mixture, preferably of a sealing paste, particularly preferably of a shield tail sealing paste, for sealing, preferably to prevent the penetration of water, of the transition between shield tail and the pipe lining or tubbing lining of the tunnel securing means, containing at least one phyllosilicate, preferably selected from the group consisting of bentonite, talc, montmorillonite, kaolinite, illite and/or sepiolite, particularly preferably bentonite, particularly preferably in an amount of 23% by weight to 45% by weight, an alkali metal salt and/or ammonium salt, preferably a carboxylate, and at least one alcohol having 1 to 5 hydroxyl groups. Preferably, the mixture contains branched or straight-chain aliphatic alcohols having 1 to 5 hydroxyl groups, particularly preferably having 1 to 3 and very particularly preferably having 1 to 2 hydroxyl groups. Preferably, the aliphatic alcohols have 2 to 24 carbon atoms, particularly preferably 2 to 7 carbon atoms. The aliphatic alcohols may in each case be branched or straight-chain. Ethylene glycol (HO—CH₂CH₂—OH) and propylene glycol (HO—CHMeCH₂—OH) are most preferred.

Also preferred are polyalkylene glycols having a molecular mass of up to 10 000 Da, particularly preferably polyalkylene glycols having a molecular mass of up to 1600 Da, especially preferably polyalkylene glycols having a molecular mass of up to 600 Da. In particular, polyalkylene glycols having two hydroxyl groups are preferred.

By using the alkali metal salts and/or ammonium salts according to the invention and at least one alcohol having 1 to 5 hydroxyl groups, together with the phyllosilicates, preferably phyllosilicates in an amount of 23 to 45% by weight, preferably as bentonite, it was possible to avoid the abovementioned disadvantages of the prior art. In particular, the sealing power could be improved while maintaining good processing properties and good pumpability.

Owing to their high swellability, phyllosilicates are known as sealants. Surprisingly, it has now been found that the sealing power and at the same time the processability, in particular the pumpability, of sealing pastes based on phyllosilicates can be increased by the use of the alcohols and salts according to the invention. These synergistic effects of the alcohols and salts are particularly pronounced in the case of high proportions of phyllosilicates in the mixtures according to the invention or a high ratio of phyllosilicate to water. In the text below and in the claims, this is to be further described in detail.

The phyllosilicates according to the invention are not particularly limited and are selected from preferably bentonite, talc, montmorillonite, illite, kaolinite, sepiolite, mica and/or members of the mica group, such as, for example, margarite and/or muscovite. In an embodiment of the invention, bentonite, talc, montmorillonite, illite, kaolinite and/or sepiolite are particularly preferred. Bentonite, talc, montmorillonite, illite and/or kaolinite are especially preferred. Bentonite is most preferred. The phyllosilicates can be used individually or as mixtures. Their environmental compatibility as a natural inorganic material is undisputed.

Phyllosilicates are distinguished by their good sealing power, in particular for preventing penetration of water and also other undesired substances (soil, mortar, sand, stones . . . ). Phyllosilicates, in particular bentonite, swell to a certain degree on contact or mixing with water. This effect is particularly pronounced in the case of a relatively high weight ratio of phyllosilicate to water. A weight ratio of phyllosilicate to water or preferably of bentonite to water of from 0.3 to 1.1 is particularly preferred, especially preferably from 0.5 to 0.6.

Phyllosilicates are substantially water-insoluble materials which form relatively viscous masses with water, in particular with small amounts of water. In particular, this is the case with bentonite. The reduction of the amount of water results in a deterioration in the processability of the pastes, particularly when working without further additives according to the invention. For example, the mixtures described in the three abovementioned documents of the prior art (in particular with the use of a relatively high proportion of phyllosilicate), inter alia with the use of bentonite, are very stiff and therefore not readily processable and not pumpable. These problems arise in particular with the use of more than 23% by weight of phyllosilicate or bentonite, in particular with the use of more than 35% by weight, based on the total mixture.

The mixture furthermore contains an alkali metal salt and/or ammonium salt, preferably an alkali metal salt, particularly preferably a sodium salt. For example, the salts LiCl, NaCl, KCl, NH₄Cl, LiBr, NaBr, ammonium sulphate and/or KBr may be used. In the series of the inorganic alkali metal and/or ammonium salts, NaCl, KCl and/or NH₄Cl are particularly preferred and especially NaCl and KCl are preferred.

In a particularly preferred embodiment of the invention, the alkali metal and/or ammonium salt is a carboxylate, preferably a nonaromatic carboxylate, particularly preferably a carboxylate having 1 to 5 carbon atoms. An alkali metal propionate is very particularly preferred, in particular sodium propionate. For example, formates, acetates and/or caprates are also suitable for use, in each case preferably as alkali metal salt and particularly preferably as sodium salt.

It is also possible to use dicarboxylate compounds, preferably those having two to 5 carbon atoms, such as, for example, maleates, fumarates, glyoxalates, succinates, adipates and/or tartrates. The corresponding alkali metal salt compounds, in particular the sodium salts, are preferred. Monocarboxylates are preferred to dicarboxylates.

The alkali metal salts and/or ammonium salts are preferably present in an amount of 0.1 to 15% by weight, particularly preferably 2 to 4% by weight, in the mixtures. The data are based in each case on the total weight of the mixture. The alkali metal salts and/or ammonium salts may be used alone or mixtures of these salts may be used.

The alkali metal salts and/or ammonium salts result in particular in improved processability and an increase in the pumpability compared with comparative mixtures without this addition. Without addition of the salts according to the invention, the mixtures would be too stiff.

According to the invention, alcohols having 1 to 5 hydroxyl groups, particularly preferably aliphatic alcohols having 1 to 5 hydroxyl groups, are present in the mixtures. The aliphatic moiety may be either branched or straight-chain. Particularly preferred are aliphatic alcohols having 1 to 3 hydroxyl groups, preferably 1 or 2 hydroxyl groups, and a number of 2 to 24 carbon atoms, particularly preferably 2 to 7 carbon atoms. Ethylene glycol (HO—CH₂CH₂—OH) and propylene glycol (HO—CHMeCH₂—OH) are most preferred.

For example, methanol, ethanol, 1-propyl alcohol, isopropyl alcohol, 1-butanol, 2-butanol, 1-hydroxy-2-methylpropane, 2-hydroxy-2-methylpropane, pentanols, hexanols and furthermore diols, such as, preferably, ethylene glycol, propylene glycol, 1,2-butanediol, 1,4-butanediol and, from the series consisting of the triols, preferably glycerol (HO—CH₂—CH(OH)—CH₂—OH) can be used. Sugars, such as, for example, glucose, may be mentioned as an example of alcohols having a relatively large number of hydroxyl groups.

In a particularly preferred embodiment of the invention, polyalkylene glycols are used. Polyalkylene glycols having a molecular mass of up to 10 000 Da, particularly preferably polyalkylene glycols having a molecular mass of up to 1600 Da, especially preferably polyalkylene glycols having a molecular mass of up to 600 Da, are preferred. Polyethylene glycols, polypropylene glycols and/or polybutylene glycols may be mentioned by way of example. The polyalkylene glycols may be composed of one type of alkylene glycol or of a plurality of types and may be present both in the form of block polymers and in the form of copolymers having a more or less random distribution of the monomer units. Polyethylene glycols or, in the case of mixed polyalkylene glycols, those polymers having a high proportion of ethylene glycol, preferably greater than 90% by weight, are preferred, in order to ensure sufficient solubility in water.

In particular, polyalkylene glycols having two hydroxyl groups are preferred. Monohydroxypolyalkylene glycols, which can be obtained, for example, by derivatization of one of the hydroxyl groups, may also be used.

In an embodiment of the invention, the alcohols in the mixture are polyalkylene glycols having a molecular mass of up to 1600, particularly preferably 600, Da.

In a further particularly preferred embodiment of the invention, glycols are used. In particular, ethylene glycol and propylene glycol are preferred.

The abovementioned alcohols are preferably present in the mixtures in each case in an amount of 1.0 to 25% by weight, particularly preferably 1 to 5% by weight. The abovementioned alcohols according to the invention can be used alone or as a corresponding mixture of alcohols. Aliphatic alcohols having 1 to 5 hydroxyl groups are preferred to the polyalkylene glycols.

Similarly to the alkali metal salts and/or ammonium salts according to the invention, the alcohols according to the invention also result in improved processability or pumpability in combination with better sealing. Surprisingly, it was found that, when the alcohols and salts are used together, synergistic effects can be achieved. Particularly advantageously, as mentioned above, the sealing power and at the same time the processability or pumpability can be improved. This effect was surprising and thus not to be foreseen.

In particular, it is possible in this way, without substantial disadvantage regarding the processability and pumpability, also to use mixtures having a preferably relatively high phyllosilicate/water weight ratio of from 0.3 to 1.1, preferably from 0.5 to 0.6, particularly preferably a high proportion of phyllosilicate of, preferably, 23 to 45% by weight. Such a mixture consequently has a higher proportion of active substances (in particular more phyllosilicate, preferably bentonite, and less water) and is therefore generally more productive. The saving of water in the mixtures according to the invention has the additional advantage that the swellability of the sealing compounds on contact with water, preferably with water from the environment of the tunnel boring machine (e.g. groundwater), is greater than if a comparatively large amount of water is present in the sealing compounds. As already mentioned, this likewise leads to improved sealing capability of the sealing pastes.

In contrast to the prior art, which recommends the use of hydrophobic constituents, such as oils, preferably no oils or only oils in small amounts, preferably in a proportion of less than 5% by weight, based on the mixture, are to be used in this invention. An excessively high proportion of oil can, owing to the resulting hydrophobization of the phyllosilicate, have the result that the phyllosilicate cannot swell sufficiently or cannot swell sufficiently rapidly, owing to insufficient wetting with water. The sealing power may be adversely affected thereby.

In an embodiment of the invention, the mixture contains

23 to 45% by weight of phyllosilicate, preferably bentonite,
1 to 25% by weight of (preferably aliphatic) alcohol having 1 to 5 hydroxyl groups, preferably glycol, particularly preferably ethylene glycol and/or propylene glycol,
0.1 to 15% by weight, preferably 1 to 5% by weight and particularly preferably 2 to 3% by weight of alkali metal salt and/or ammonium salt, preferably sodium salt and particularly preferably a carboxylate having 1 to 5 carbon atoms and
40 to 75% by weight of water.

In particular, alkali metal propionates, especially sodium propionate, are suitable as carboxylate.

Mixtures which contain fibres are also particularly advantageous. The fibres result in the mechanical stability and the water resistance of the mixtures being increased. Preferably, the fibres are present in a proportion by weight of greater than 0 to 25% by weight, particularly preferably 3 to 10% by weight. The fibres are preferably fibres having a length of greater than 0 to 9 mm, particularly preferably of greater than 0 to 6 mm. Fibre mixtures comprising natural fibres, in particular cellulose fibres, and manmade fibres, in particular polyamide, polypropylene and/or polyethylene fibres, are most preferred. Mixtures of natural fibres and manmade fibres, in particular mixtures of long and short fibres, have the advantage that they increase the compressive strength relative to water.

Furthermore, particularly advantageous mixtures are those which contain at least two different lengths of fibres, particularly preferably fibres having a length of less than 1 mm and fibres having a length of greater than 1 mm being simultaneously present. Mixtures of natural fibres and manmade fibres are particularly preferred, the natural fibres preferably being smaller than 1 mm and the manmade fibres preferably larger than 1 mm and smaller than 9 mm.

Mixtures which contain fibres of different length, in particular mixtures which have as broad a distribution as possible over the total preferred fibre length range of greater than 0 to 9 mm, are preferred particularly because these specific fibre mixtures are particularly suitable for sealing against running water under pressure. This effect is even more pronounced when changing over to small natural fibres, such as cellulose fibres, having a length of less than 1 mm and using manmade fibres having a length of greater than 1 mm to 9 mm. Firstly, natural fibre mixtures (e.g. cellulose) of small length can be cheaply obtained commercially, secondly are also effective since it may be assumed that these fibres are also likely to have a slight tendency towards swelling with water.

The proportion of the preferably natural fibres having a length of less than 1 mm is preferably in the range from 50 to 90% by weight and particularly preferably in the range from 60 to 80% by weight, based in each case on the total weight of the fibres.

The invention also relates to the use of the mixture(s) according to the invention for preferably temporary sealing of construction elements and/or construction machines, particularly preferably for preferably temporary sealing of the transition between shield tail and the pipe lining or tubbing lining of the tunnel securing means. The initially outlined problems of the sealing pastes known from the prior art, in particular shield tail sealing pastes, are substantially avoided with the use of the mixtures according to the invention, in particular of the preferred mixtures according to any of the dependent claims.

So-called drainage walls which are preferably intended for temporary protection (for example during the implementation of other construction work) from the penetration of water should be mentioned as an example of sealing of construction elements. Moreover, leaking pipelines can initially be sealed by the mixtures according to the invention until renovation of the affected (water) pipe can be effected. A multiplicity of further (sealing) applications of a similar type is conceivable.

An example of the sealing of a construction machine is the preferably temporary sealing of the transition between the shield tail of a tunnel boring machine and the pipe lining or tubbing lining of the tunnel securing means.

### EXAMPLES

### 1. Preparation of the Sealing Compounds

The preparation of the sealing compounds was effected in a customary mixer for pastes or highly viscous substances. For this purpose, all constituents are stirred until a homogeneous material is obtained.

### 2. Penetration Test

The penetration test (cone penetration test) was carried out according to ASTM D217-02. This test serves for determining the processability or pumpability of the sealing compounds. A value of 150/10 mm to 300/10 mm guarantees good processability and pumpability of the materials. The results of the penetration test for the sealing compounds are summarized in Table 1.

### 3. Water Pressure Test

The water pressure test serves for determining the sealing power of the sealing pastes with respect to water under pressure. This test is carried out according to the Matsumara test known in this technical area. The sealing compound to be tested is applied to a metal grid of 0.5 mm grid spacing and the test is carried out in a corresponding apparatus at a pressure of 8 bar (in a modification of the Matsumara test). The test is considered to have been passed if no water penetrates through the sealing compound during a time of five minutes. The results of the water pressure test for the sealing compounds are likewise summarized in Table 1.

It is found that the presence of the salts and alcohols according to the invention in Examples P-1 to P-26 according to the invention improves the processability or pumpability of the sealing compounds so that the requirements of the test are fulfilled. By using the additives salt and alcohol, the compounds are made somewhat more plastic and therefore better processable.

Surprisingly, no deterioration in the results in the water pressure test is observed as a consequence of the somewhat softer formulation of the compounds. This is otherwise frequently the case if the additives according to the invention are not employed. The results from Table 1 show good results throughout (passed).

As shown by Examples P-6 to P-10 and P-24, it is also possible to use higher proportions of phyllosilicate without obtaining excessively stiff sealing compounds and hence less readily processable sealing compounds. The sealing behaviour is particularly good in the case of higher proportions of phyllosilicate, but provided that the additives according to the invention are used.

In contrast, Comparative Examples C1 (without salt), C3 and C4 (in each case without salt and without alcohol) pass neither the penetration test nor the water pressure test. C4 shows that, particularly in the case of high proportions of phyllosilicate and relatively little water, the two tests are not passed since the sealing compounds are too stiff. C2 (without alcohol), for example, does not pass the water pressure test.

The results show that, by using the salts and alcohols according to the invention, surprisingly both very good sealing properties and particularly good processability, in particular pumpability, can be achieved.

TABLE 1

| | | | | | | | | Cellulose | |
|---|---|---|---|---|---|---|---|---|---|
| | | Water | | | | | | fibres | PP fibres |
| | Pene- | pressure | Den- | Water | Phyllosilicate | Salt | Alcohol | 440 μm | 6 mm |
| Sam- | tration | test | sity | (% by | (% by | (% by | (% by | (% by | (% by |
| ple | (/10 mm) | (0.5 mm) | (g/cm³) | weight) | weight) | weight) | weight) | weight) | weight) |
| P-1 | 275 | passed | 1.20 | 41.90 | Bentonite (28.50) | Na propionate (0.86) | Ethylene glycol (24.00) | 3.25 | 1.50 |
| P-2 | 168 | passed | 1.26 | 46.25 | Bentonite (28.50) | Na propionate (0.50) | Ethylene glycol (20.00) | 3.25 | 1.50 |
| P-3 | 267 | passed | 1.28 | 57.10 | Bentonite (32.30) | Na propionate (2.80) | Ethylene glycol (2.00) | 4.35 | 1.45 |
| P-4 | 252 | passed | 1.31 | 58.15 | Bentonite (30.30) | Na propionate (2.75) | Ethylene glycol (3.00) | 4.35 | 1.45 |
| P-5 | 256 | passed | 1.20 | 58.15 | Bentonite (30.30) | Na propionate (2.75) | Ethylene glycol (3.00) | 4.35 | 1.45 |
| P-6 | 195 | passed | 1.34 | 51.39 | Bentonite (38.85) | Na propionate (2.51) | Ethylene glycol (2.5) | 3.25 | 1.50 |
| P-7 | 244 | passed | 1.36 | 50.54 | Bentonite (37.85) | Na propionate (4.36) | Ethylene glycol (2.5) | 3.25 | 1.50 |
| P-8 | 265 | passed | 1.34 | 51.46 | Bentonite (36.85) | Na propionate (4.44) | Ethylene glycol (2.5) | 3.25 | 1.50 |
| P-9 | 241 | passed | 1.26 | 49.90 | Bentonite (38.55) | Na propionate (4.30) | Ethylene glycol (2.5) | 3.25 | 1.50 |
| P-10 | 248 | passed | 1.29 | 50.17 | Bentonite (38.25) | Na propionate (4.33) | Ethylene glycol (2.5) | 3.25 | 1.50 |
| P-11 | 260 | passed | 1.20 | 58.15 | Bentonite (30.30) | Na propionate (2.75) | Ethylene glycol (3.00) | 4.35 | 1.45 |
| P-12 | 248 | passed | 1.25 | 58.40 | Bentonite (30.30) | NaCl (2.50) | Ethylene glycol (3.00) | 4.35 | 1.45 |
| P-13 | 258 | passed | 1.26 | 58.40 | Bentonite (30.30) | Na acetate (2.50) | Ethylene glycol (3.00) | 4.35 | 1.45 |
| P-14 | 227 | passed | 1.26 | 58.40 | Bentonite (30.30) | Na lactate (2.50) | Ethylene glycol (3.00) | 4.35 | 1.45 |
| P-15 | 249 | passed | 1.21 | 58.15 | Bentonite (30.30) | Na caproate (2.75) | Ethylene glycol (3.00) | 4.35 | 1.45 |
| P-16 | 244 | passed | 1.21 | 58.15 | Bentonite (30.30) | Mg propionate (2.75) | Ethylene glycol (3.00) | 4.35 | 1.45 |
| P-17 | 245 | passed | 1.22 | 58.15 | Bentonite (30.30) | (NH₄)₂SO₄ (2.75) | Ethylene glycol (3.00) | 4.35 | 1.45 |
| P-18 | 188 | passed | 1.25 | 57.65 | Bentonite (30.30) | Na propionate (2.75) | PEG-200 (3.5) | 4.35 | 1.45 |
| P-19 | 195 | passed | 1.25 | 58.15 | Bentonite (30.30) | Na propionate (2.75) | PEG-400 (3.0) | 4.35 | 1.45 |
| P-20 | 247 | passed | 1.23 | 58.15 | Bentonite (30.30) | Na propionate (2.75) | Isopropanol (3.00) | 4.35 | 1.45 |
| P-21 | 258 | passed | 1.16 | 58.15 | Bentonite (30.30) | Na propionate (2.75) | Propylene glycol (3.00) | 4.35 | 1.45 |
| P-22 | 276 | passed | 1.28 | 58.15 | Bentonite (30.30) | Na propionate (2.75) | Glycerol (3.00) | 4.35 | 1.45 |
| P-23 | 232 | passed | 1.29 | 43.90 | Bentonite (30.30) | Na propionate (10.00) | Ethylene glycol (10.00) | 4.35 | 1.45 |
| P-24 | 265 | passed | 1.45 | 45.09 | Kaolinite (44.00) | Na propionate (2.11) | Ethylene glycol (3.00) | 4.35 | 1.45 |
| P-25 | 223 | passed | 1.27 | 58.15 | Illite (30.30) | Na propionate (2.75) | Ethylene glycol (3.00) | 4.35 | 1.45 |
| P-26 | 265 | passed | 1.33 | 53.67 | Montmorillonite | Na propionate (2.53) | Ethylene glycol (3.00) | 4.35 | 1.45 |
| | | | | | (35.00) | | | | |
| C-1 | 101 | not passed | 1.17 | 59.10 | Bentonite (32.10) | | Ethylene glycol (3.00) | 4.35 | 1.45 |
| C-2 | 225 | not passed | 1.31 | 57.40 | Bentonite (35.00) | Na propionate (2.57) | | 4.00 | 1.00 |
| C-3 | 102 | not passed | 1.19 | 63.90 | Bentonite (30.30) | | | 4.35 | 1.45 |
| C-4 | 95 | not passed | 1.34 | 57.25 | Bentonite (38.00) | | | 3.25 | 1.50 |

1. Mixture containing at least one phyllosilicate, an alkali metal salt and/or ammonium salt and at least one alcohol having 1 to 5 hydroxyl groups.

2. Mixture according to claim 1, wherein the alkali metal salt and/or ammonium salt represents a carboxylate.

3. Mixture according to claim 1, wherein bentonite, talc, montmorillonite, kaolinite, illite and/or sepiolite is present as the phyllosilicate.

4. Mixture according to claim 1 wherein the alcohol is a branched or straight-chain aliphatic alcohol.

5. Mixture according to claim 1, wherein the alcohol is a glycol.

6. Mixture according to claim 1, wherein the mixture contains polyalkylene glycols having a molecular mass of up to 1600 Da.

7. Mixture according to claim 1, wherein the mixture contains from 23 to 45% by weight of phyllosilicate.

8. Mixture according to claim 1, wherein water is present and the weight ratio of phyllosilicate to water is from 0.3 to 1.1.

9. Mixture according to claim 1, wherein the mixture contains fibres.

10. Mixture according to claim 9, wherein the mixture contains at least two different lengths of fibres.

11. Mixture according to claim 1, wherein the alcohol is present in an amount of 1 to 25% by weight.

12. Mixture according to claim 1, wherein the alkali metal salt and/or ammonium salt is present in an amount of 0.1 to 15% by weight.

13. Mixture according to claim 1, wherein
23 to 45% by weight of phyllosilicate,
1 to 25% by weight of alcohol having 1 to 5 hydroxyl groups,
0.1 to 15% by weight of alkali metal salt and/or ammonium salt and
40 to 75% by weight of water are present.

14. Process comprising sealing construction elements and/or construction machines with a mixture according to claim 1.

15. Mixture according to claim 1, wherein
23 to 45% by weight of phyllosilicate,
1 to 25% by weight of alcohol having 1 to 5 hydroxyl groups,
1 to 5% by weight of alkali metal salt and/or ammonium salt and
40 to 75% by weight of water are present.

16. Mixture according to claim 1, wherein
23 to 45% by weight of phyllosilicate,
1 to 25% by weight of alcohol having 1 to 5 hydroxyl groups,
2 to 3% by weight of alkali metal salt and/or ammonium salt and
40 to 75% by weight of water are present.
